(19) United States
(12) Patent Application Publication
(10) Pub. No.: US 2017/0235899 A1
(43) Pub. Date: Aug. 17, 2017

(54) IDENTIFICATION AND PROFILING OF FOCUS AREAS

(71) Applicant: Amino, Inc., San Francisco, CA (US)

(72) Inventors: Abraham M. Othman, San Francisco, CA (US); Jorge A. Caballero, Menlo Park, CA (US); David A. Vivero, San Francisco, CA (US); Abhinav Chowdary Yarlagadda, San Francisco, CA (US); Mary Audrey Hampden, Alameda, CA (US); Sumul Mahendra Shah, Alameda, CA (US); Rebecca Ackermann, San Francisco, CA (US)

(21) Appl. No.: 15/043,116

(22) Filed: Feb. 12, 2016

(51) Int. Cl. G06F 19/00; G06F 17/30

(52) U.S. Cl. CPC G06F 19/328; G06F 19/345; G06F 17/30598; G06F 17/30592

(57) ABSTRACT

Disclosed are methods and systems for identifying and profiling focus areas of healthcare providers. Embodiments include technology that identifies focus areas automatically from healthcare information such as diagnoses and procedures. As such, healthcare providers that frequently diagnose and/or treat patients for similar conditions may be automatically grouped into the same cluster. Expert knowledge may then be used to label a cluster as a focus area.

### TECHNICAL FIELD

The invention relates to the identification and profiling of focus areas. The invention more particularly relates to methods and systems for identifying and profiling focus areas of healthcare providers based on collected healthcare information.

### BACKGROUND

Healthcare providers (e.g., doctors) may be affiliated with particular focus areas (e.g., a specialty or expertise). The affiliation may be based on training, a license, practical experience, and/or simply self-identifying with a focus area. As such, a purported focus area may be inconsistent from a doctor's actual focus area if the doctor lacks training, a license, or practical experience in the purported focus area. For example, a licensed endocrinologist may have more experience (and greater talent) practicing general internal medicine. As a result, healthcare consumers (e.g., patients) are faced with unreliable classifications when selecting a doctor in a focus area. Accordingly, a need exists for accurately identifying and profiling focus areas of healthcare providers.

### BRIEF DESCRIPTION OF THE DRAWINGS

FIG. 1 is a block diagram of a system that utilizes healthcare information to discover and profile focus areas of healthcare providers according to some embodiments of the present disclosure;

FIG. 2 is a sequence diagram that illustrates a process for utilizing healthcare information to identify and profile focus areas of healthcare providers according to some embodiments of the present disclosure;

FIG. 3 is a flowchart that illustrates a process performed by a focus areas server for identifying and profiling focus areas according to some embodiments of the present disclosure;

FIG. 4 depicts a visual representation of clusters corresponding to focus areas according to some embodiments of the present disclosure;

FIG. 5 is a screenshot that illustrate a user interface (UI) including a description of a focus area according to some embodiments of the present disclosure;

FIG. 6 includes screenshots that illustrate operations of a “section switcher” for navigating through sections of the UI according to some embodiments of the present disclosure;

FIGS. 7A through 7I are screenshots of sequential pages that are accessed by scrolling the UI according to some embodiments of the present disclosure; and

FIG. 8 is a block diagram of a computer operable to implement the disclosed technology according to some embodiments of the present disclosure.

### DETAILED DESCRIPTION

The embodiments set forth below represent the necessary information to enable those skilled in the art to practice the embodiments, and illustrate the best mode of practicing the embodiments. Upon reading the following description in light of the accompanying drawing figures, those skilled in the art will understand the concepts of the disclosure and will recognize applications of these concepts that are not particularly addressed herein. It should be understood that these concepts and applications fall within the scope of the disclosure and the accompanying claims.

The purpose of terminology used herein is only for describing embodiments and is not intended to limit the scope of the disclosure. Where context permits, words using singular or plural form may also include the plural or singular form, respectively.

As used herein, unless specifically stated otherwise, terms such as “processing,” “computing,” “calculating,” “determining,” “displaying,” “generating” or the like, refer to actions and processes of a computer or similar electronic computing device, that manipulates and transforms data represented as physical (electronic) quantities within the computer's memory or registers into other data similarly represented as physical quantities within the computer's memory, registers, or other such storage medium, transmission, or display devices.

As used herein, the term “healthcare consumer” refers to a person who receives services from a healthcare provider or may utilize the technology disclosed herein. The term “patient” refers to a person who receives services from a healthcare provider. Lastly, the term “user” is a person who may utilize the technology disclosed herein.

As used herein, the term “healthcare provider” refers to any person, facility, or object that provides healthcare services, or services related to healthcare. Examples include a doctor, nurse practitioner, physician's assistant, physical therapist, massage therapist, acupuncturist, chiropractor, herbalist, healthcare facility, healthcare practice group, medical center, insurance, pharmacy, or the like.

As used herein, the term “healthcare professional” includes a person or entity treating a patient, such as a doctor, nurse practitioner, physician's assistant, physical therapist, massage therapist, acupuncturist, chiropractor, herbalist, or the like.

As used herein, the term “healthcare issue” refers to a medical condition of a patient and/or a related medical service such as a symptom, procedure, test, diagnosis, drug, treatment, or the like.

As used herein, the terms “connected,” “coupled,” or variants thereof, mean any connection or coupling, either direct or indirect, between two or more elements. The coupling or connection between the elements can be physical, logical, or a combination thereof.

Disclosed are methods and systems for identifying and profiling focus areas of healthcare providers. As used herein, the terms “focus area” and “clinical focus area” are synonymous and refer to a broad classification of a medical subject, concept, or idea practiced by healthcare providers. A focus area may be distinct from, overlapping, or subsumed by another focus area.

In some embodiments, the disclosed technology identifies the focus areas automatically from healthcare information, such as millions or billions of medical records. For example, healthcare issues (e.g., diagnoses and procedures) from the healthcare information may be processed to identify clusters based on frequencies of care for patients. For example, doctors that frequently diagnose and/or treat patients for similar medical conditions may be automatically grouped into a cluster. Expert knowledge may then be used to label a cluster as a focus area.

As a result, the disclosed clustering technology could be utilized in various applications to properly define focus areas, improve accurate classifications of healthcare providers, improve medical training and licensing, reduce the risks of improper care, improve healthcare consumer outcomes, and the like.

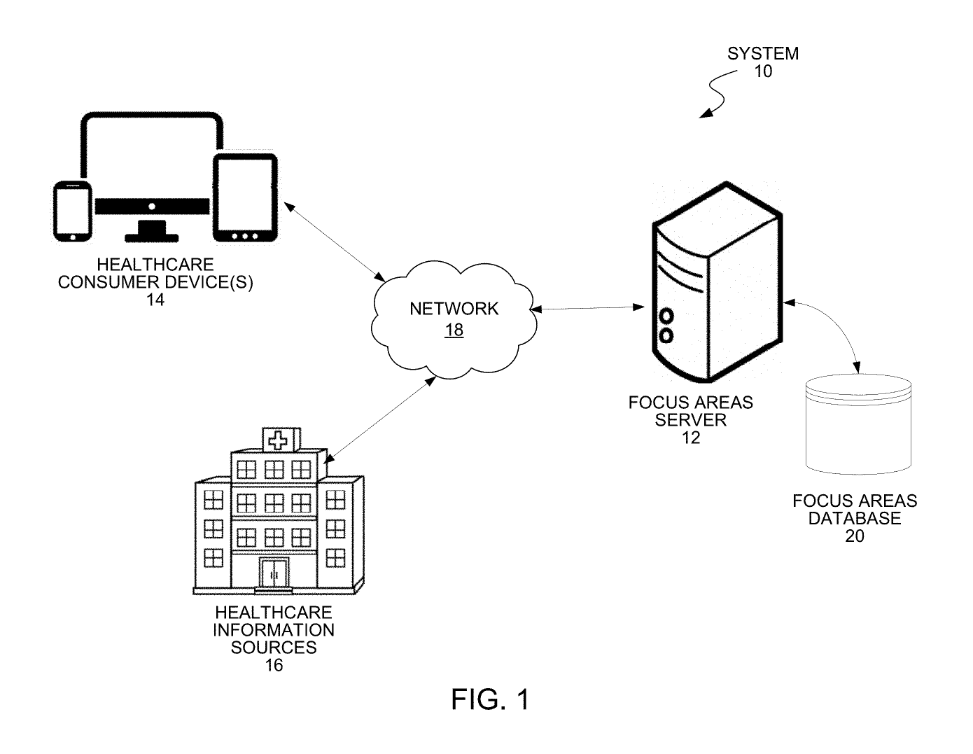

FIG. 1 is a block diagram of a system that utilizes healthcare information to discover and profile focus areas of healthcare providers according to some embodiments of the present disclosure. As shown, the system 10 includes components such as a focus areas server 12, healthcare consumer devices 14, and healthcare information sources 16, all of which are interconnected over a network 18 such as the Internet. Also shown is a focus areas database 20 connected to the focus areas server 12.

The network 18 may include any combination of private, public, wired, or wireless portions. The data communicated over network 18 may be encrypted or unencrypted at various locations or along different portions of network 18. Each component of the system 10 may include combinations of hardware and/or software to process data, perform functions, communicate over the network 18, and the like. For example, any component of the system 10 may include a processor, memory or storage, a network transceiver, a display, operating system and application software (e.g., for providing a user interface), and the like. Other components, hardware, and/or software included in the system 10 that are well-known to persons skilled in the art are not shown or discussed herein for brevity.

The healthcare consumer devices 14 (referred to herein collectively as healthcare consumer devices 14 and individually as healthcare consumer device 14) are used by healthcare consumers to interact with the system 10. Examples of healthcare consumer devices 14 devices include smart phones (e.g., Apple iPhone, Samsung Galaxy, Nokia Lumina), tablet computers (e.g., Apple iPad, Samsung Note, Amazon Fire, Microsoft Surface), computers (e.g., Apple MacBook, Lenovo 440), and any other device that is capable of accessing healthcare information provided by the focus areas server 12 over the network 18.

The focus areas server 12 may include any number of server computers that operate to identify and/or profile focus areas based on information provided by the healthcare information sources 16 over network 18. In some embodiments, the focus areas server 12 may also provide a portal that allows healthcare consumers to access a library of information related to the identified focus areas. Examples of a portal include a website or channels for providing information about related focus areas to the healthcare consumer devices 14. As such, the healthcare consumer devices 14 can access information about focus areas through the portal provided by the focus area server 12.

In some embodiments, the focus areas database 20 may operate to store healthcare information retrieved from the healthcare information sources 16 for identifying and profiling focus areas. The healthcare information sources 16 may include any source of healthcare information. For example, the healthcare information sources 16 may include any healthcare provider including medical facilities, private offices, or devices operated by healthcare professionals. In some embodiments, the healthcare information may include at least portions of medical records utilized for discovering and profiling focus areas.

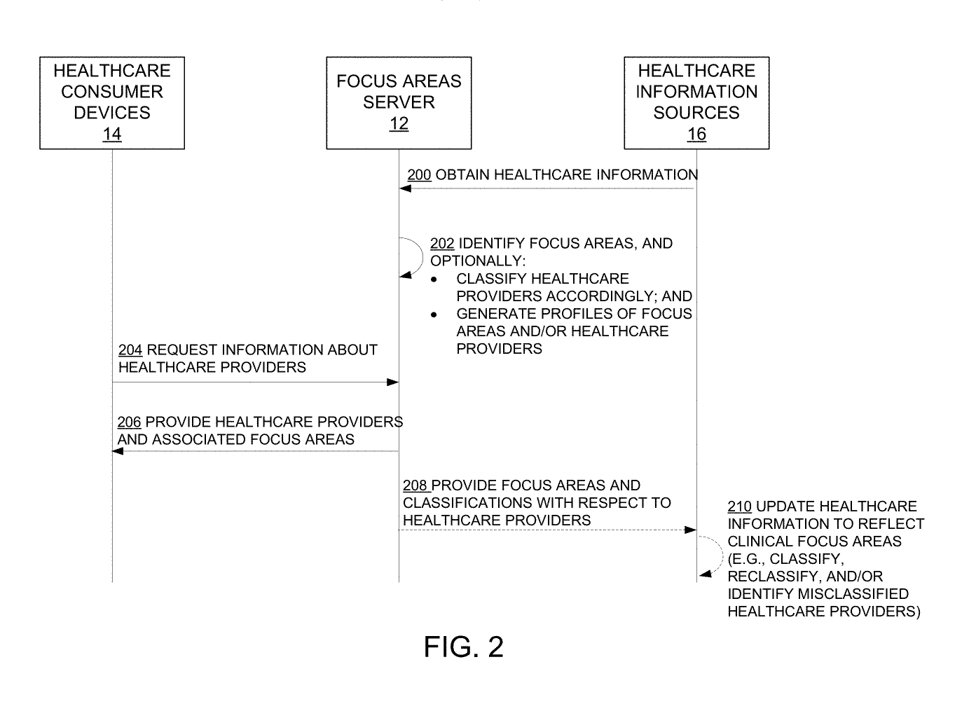

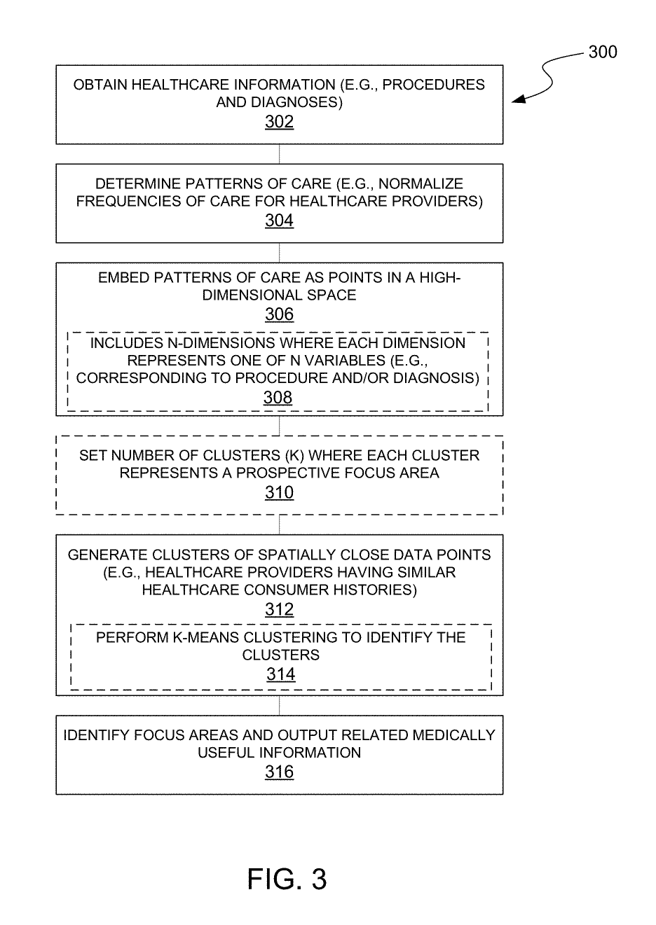

As detailed further below, FIGS. 2 and 3 are a sequence diagram and flowchart, respectively, that illustrate embodiments of the disclosed clustering technology. However, this disclosure is not limited to the embodiments of FIGS. 2 and 3, and instead broadly covers focus areas translated from healthcare providers' (e.g., specialists') patterns of care (e.g., their frequencies of seeing patients for various procedures and with various diagnoses) into broadly understandable classifications. In some embodiments, the focus areas are generated automatically by utilizing an algorithm to process millions or billions of medical records. The focus areas may then be labeled as such by using human expert medical knowledge.

To cluster healthcare providers (e.g., doctors), the disclosed clustering technology may begin by normalizing doctors' frequencies of care for patients based on procedures they perform and diagnoses of healthcare consumers (e.g., patients) they see. In some embodiments, the disclosed clustering technology embeds the providers' patterns of care as points in a high-dimensional space, where each dimension corresponds to a specific procedure and/or diagnosis.

The disclosed clustering technology may then run a clustering algorithm (e.g., a k-means algorithm as detailed at en.wikipedia.org/wiki/K-means_clustering) in that high- (i.e., large) dimensional space. Notably, k-means clustering is a standard unsupervised learning algorithm that identifies groups of spatially close data points—in this case, that may mean finding doctors that have similar patient histories. In some embodiments, the number of clusters (k) is set in each specialty by using medical intuition about the potential number of focus areas in each cluster (i.e., focus areas in a specialty). Each focus area then corresponds to one or more of these automatically generated clusters.

In some embodiments, the output of the clustering algorithm may be (i) an assignment of specialists to clusters and/or (ii) cluster centers, which represent the “average” doctor in each prospective focus area. These outputs may then be analyzed to label a prospective focus area. Notably, the inventors have found that high-volume healthcare providers within a prospective focus area often had an academic affiliation or otherwise maintained a separate web presence identifying their focus area, and these factors helped guide the labeling process. However, if the identity of the cluster was not medically obvious, it was not given a label.

FIG. 2 is a sequence diagram that illustrates a process for utilizing healthcare information to identify and profile focus areas of healthcare providers according to some embodiments of the present disclosure. As shown, in step 200, the focus areas server 12 obtains healthcare information from the healthcare information sources 16. In some embodiments, the healthcare information may include any number of medical records. In some embodiments, the healthcare information may not include complete information from each medical record. For example, the healthcare information may include procedures, diagnoses, or other information that can be utilized to represent frequencies of care by healthcare providers. In some embodiments, types of healthcare information utilized to represent frequencies of care may be predetermined using expert knowledge.

In step 202, the focus areas server 12 operates to identify focus areas based on the obtained healthcare information. The discussion of FIG. 3 provides details of the clustering technology utilized to identify and profile focus areas. In some embodiments, the clustering technology could optionally classify healthcare providers in accordance with the identified focus areas and generate profiles of the identified focus areas and healthcare providers in the same focus area.

In step 204, the focus areas server 12 may receive a request from the healthcare consumer device 14 for information related to the identified focus areas. For example, the healthcare consumer device 14 may request a ranked list of healthcare providers in a focus area. In step 206, the focus areas server 12 may respond to the request from step 204 by providing a list of matching healthcare providers. For example, the focus areas server 12 may provide healthcare provider information via a website or software application resident on the healthcare consumer device 14. The list of matching healthcare providers may be ranked by greatest match to the focus area and/or information comparing the healthcare providers to others or the “average” healthcare providers in the same focus area.

In step 208, the focus areas server 12 may optionally provide the healthcare information sources 16 with information about the identified focus areas including, for example, information regarding the classification of healthcare providers in any focus area. Lastly, in step 210, the healthcare information sources 16 can optionally update healthcare information to reflect the identified focus areas. For example, the healthcare information sources 16 can classify or reclassify healthcare providers in accordance with the identified focus areas, and/or identify healthcare providers that are misclassified in the wrong focus areas.

FIG. 3 is a flowchart that illustrates a process 300 performed by the focus areas server 12 for identifying and profiling focus areas according to some embodiments of the present disclosure. In step 302, the focus areas server 12 obtains healthcare information (e.g. procedures and/or diagnoses).

In step 304, the focus areas server 12 determines patterns of care (e.g., frequencies of care) for the healthcare providers based on the healthcare information. The patterns of care may be determined by normalizing frequencies of care of healthcare providers. For example, a pattern of care for a doctor may be determined by normalizing the doctor's frequency for particular diagnoses and/or procedures compared to other doctors.

In step 306, the focus areas server 12 embeds the patterns of care as points in a high-dimensional space. Optionally, in step 308, the high-dimensional space has N-dimensions for N variables corresponding to, for example, the procedures and/or diagnoses. These representative variables (dimensions) for clustering are included in the data output (e.g., metadata) for the clustering. Optionally, in step 310, a number of clusters (K) may be set for a particular specialty to limit the number of prospective focus areas that are identified by the focus areas server 12.

In step 312, the focus areas server 12 identifies groups of spatially close data points that represent healthcare providers that have similar healthcare consumer histories. For example, the high-dimensional space may include groups of data points that represent doctors having patients with similar histories of diagnoses and/or procedures. In some embodiments, each group of healthcare providers represents a cluster.

Optionally, in step 314, the focus areas server 12 automatically generates a number of clusters (e.g., K clusters) by utilizing a clustering algorithm. For example, the clusters could be generated by performing k-means clustering, which is a method of vector quantization utilized for cluster analysis in data mining. Details about k-means clustering are well known to persons of skilled in art and, as such, are omitted herein for the sake of brevity. Notably, the disclosure is not limited to utilizing a k-means clustering algorithm to generate clusters. Instead, any spatial or geometric approach could be utilized to generate the clusters.

In step 316, the focus areas server 12 can utilize expert medical knowledge to label the clusters as medically meaningful focus areas. The clusters may have unique labels, duplicate labels, or may not be labeled at all. In addition, the focus areas and/or related information such as healthcare providers in the same focus areas are output for use in a variety of applications to, for example, classify healthcare providers and/or generate profiles of the identified focus areas and/or profiles of healthcare providers in the same focus areas.

As such, a cluster of Inflammatory Bowel Disease (IBD) specialists might emerge in a group of gastroenterologists by utilizing the disclosed clustering technology. IBD specialists are characterized in terms of frequencies of care that the specialists perform to treat IBD. For example, IBD specialists see a greater number of patients with Crohn's disease compared to typical gastroenterologists (e.g., 500% more frequency of care). Expert knowledge could be used to label the cluster as an IBD focus area. Moreover, the outputs of the clustering technology may include discovery of gastroenterologists that are, for example, misclassified as IBD specialists.

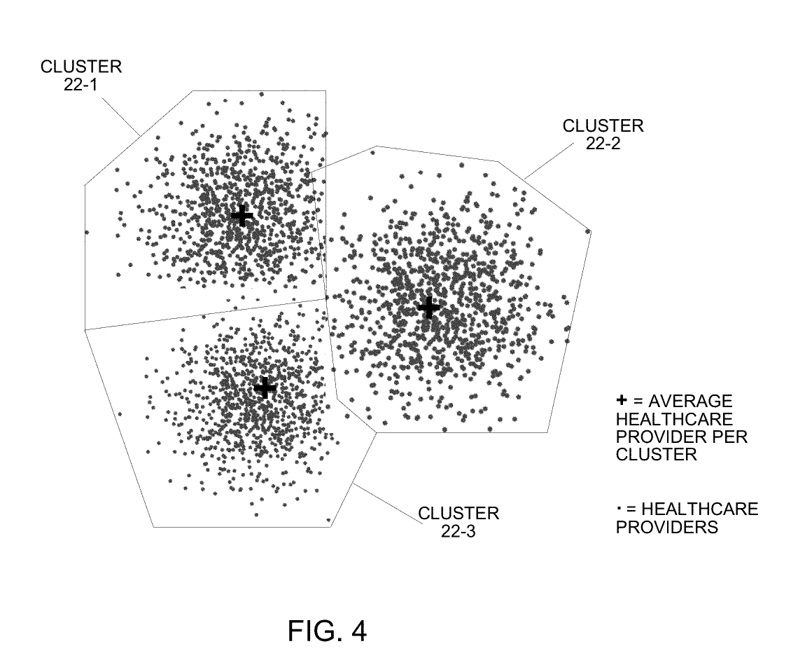

FIG. 4 depicts a visual representation of clusters corresponding to focus areas according to some embodiments of the present disclosure. As shown, data points on a plane represent healthcare providers in a space defined by diagnoses and/or procedures performed by the healthcare providers on healthcare consumers. As such, the disclosed clustering technology has automatically grouped healthcare providers into clusters 22-1, 22-2, and 22-3 based on frequencies of care. It should be noted, however, that the actual number of dimensions is typically quite large (thousands), and so FIG. 4 is more illustrative rather than reflective of reality.

As indicated above, the clustering technology can utilize expert knowledge to formulate a medically meaningful description (i.e., label) for each of the clusters 22. Each label corresponds to a focus area for healthcare providers. The “average” healthcare provider for respective clusters 22 may be determined automatically or manually before or after labeling the clusters 22. As shown, some healthcare providers are included in clusters 22-1 and 22-2, which corresponds to healthcare providers being in both focus areas.

The disclosed clustering technology could be utilized in various applications to properly define focus areas, improve accurate classifications of healthcare providers, improve medical training and licensing, reduce the risks of improper care, improve healthcare consumer outcomes, and the like. For example, the disclosed clustering technology could be utilized to validate known focus areas. Specifically, the automatically generated clusters could be compared to known focus areas. A correspondence between a cluster and a known clinical focus area would validate the existing focus area.

In some embodiments, the disclosed clustering technology could be utilized to discover focus areas. Specifically, new focus areas that are distinct from existing focus areas may emerge. For example, obstetric anesthesiology is a recently codified focus area that now requires board certification. The clustering technology of the present embodiments could identify healthcare providers that have practiced as obstetric anesthesiologist for quite some time. Notably, this could lead to the development of new medical training pathways.

In some embodiments, the disclosed clustering technology could be utilized to validate existing classifications of healthcare providers, discover new classifications for healthcare providers, reclassify healthcare providers, and/or identify healthcare providers that are misclassified. For example, a healthcare provider may self-identify as a specialist because of training or board certification in that specialty. However, the healthcare provider may lack practical experience in that specialty. As such, the healthcare provider may be misclassified. For example, doctors labeled as gastroenterologists or cardiologists due to their training could be misclassified if they primarily practice as general internal medicine doctors.

In some embodiments, the disclosed clustering technology could be used to identify healthcare providers that deliberately practice outside the scope of their training and/or license (e.g., a chiropractor that practices emergency medicine). As such, mistake, fraud of practice, or malpractice could be discovered. This information could be used to take corrective actions such as requiring additional training for doctors that practice outside the scope of their licenses or sanctioning doctors that deliberately mislead healthcare consumers. In addition, the disclosed clustering technology could aid healthcare providers in identifying their clinical focus areas (e.g., for marketing purposes).

In some embodiments, the disclosed clustering technology could be utilized to compare and contrast focus areas and/or healthcare providers. For example, frequencies of care for healthcare providers in the same focus area could be compared with each other or with the “average” healthcare provider. This information could be utilized to determine levels of expertise for the healthcare providers. For example, the clustering technology could be utilized to determine how a doctor is different than a typical gastroenterologist, or how an IBD doctor is different from a typical gastroenterologist.

In some embodiments, the disclosed clustering technology could be utilized by patients to find doctors that are accurately classified or to find doctors that have a clinical focus area similar to their current misclassified doctor. For example, a patient that moves to a new location may seek a new doctor that is similar to a current doctor. Rather than searching based on an unreliable classification provided by the current doctor, the disclosed clustering technology allows for identifying a new doctor that is in the same focus area as the current doctor.

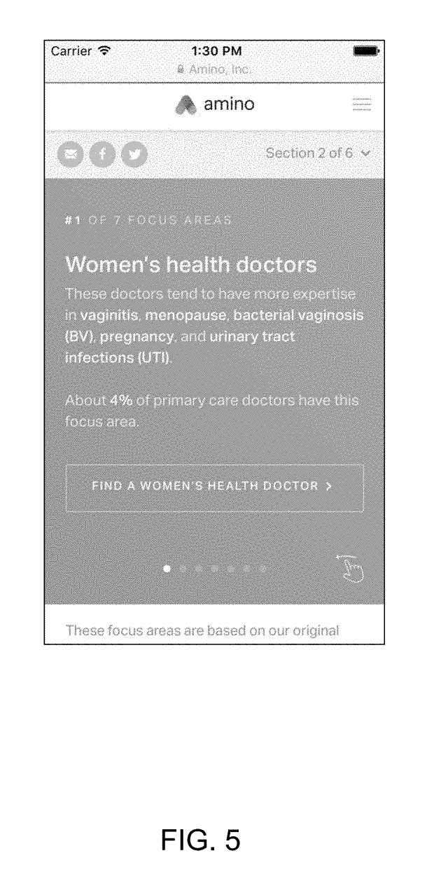

As indicated above, a healthcare consumer device 14 may access the disclosed clustering technology of system 10 via a network portal such as a website or application software (hereinafter an “app”). For example, FIGS. 5 through 7 show screenshots corresponding to pages of a user interface (UI) rendered by an app on a healthcare consumer device 14 to access the clustering technology of system 10.

FIG. 5 is a screenshot that illustrates a user interface (UI) including a description of a focus area according to some embodiments of the present disclosure. As shown, the screenshot shows information about a “women's health” focus area including scope of care and the portion (4%) of primary care doctors in this focus area. Moreover, the UI includes a link to find a doctor that practices in the focus area.

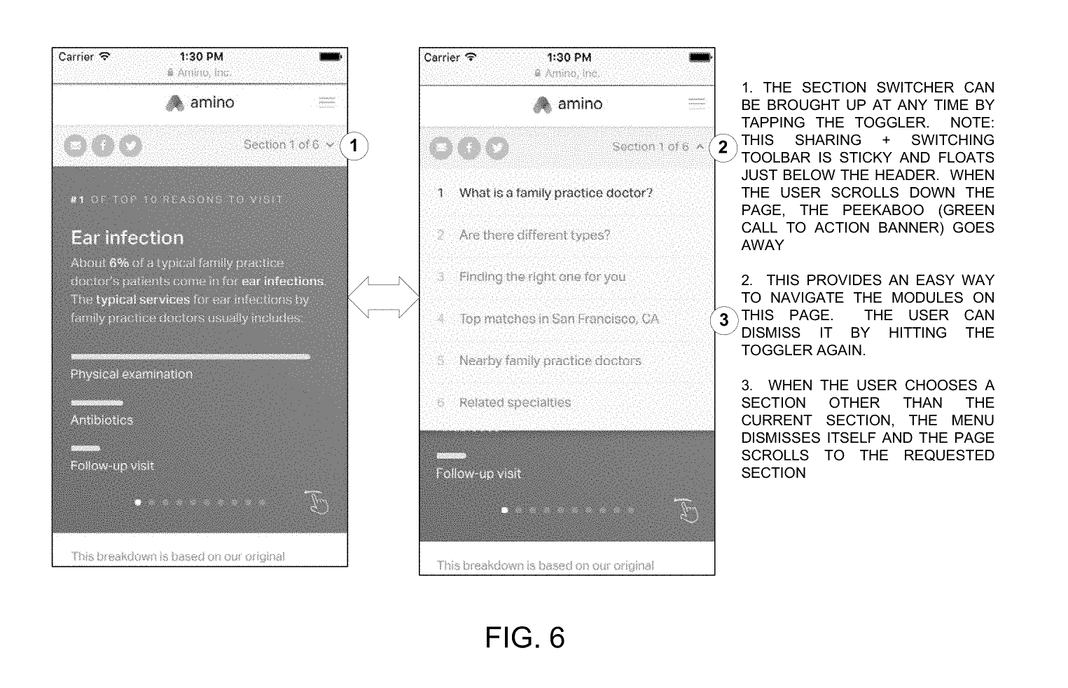

FIG. 6 includes screenshots that illustrate operations of a “section switcher” for navigating through sections of the UI according to some embodiments of the present disclosure. As shown, the screenshots include a “sharing and switching” toolbar that is sticky and floats just below the header “amino.”

The section switcher provides an easy way to navigate sections of the UI corresponding to respective modules. As shown, a user of the section switcher can open (1) or close (2) a menu of sections (3) at any time by tapping the toggler (e.g., “Section 1 of 6”). When open (right screenshot), the UI displays the menu including a list of links to respective sections. When a link to a section other than the current section is selected, the menu is dismissed and the UI scrolls to a page corresponding to the requested section. In addition, when a user scrolls down a page of the UI, a peekaboo (e.g., green call to action banner) is no longer visible (not shown).

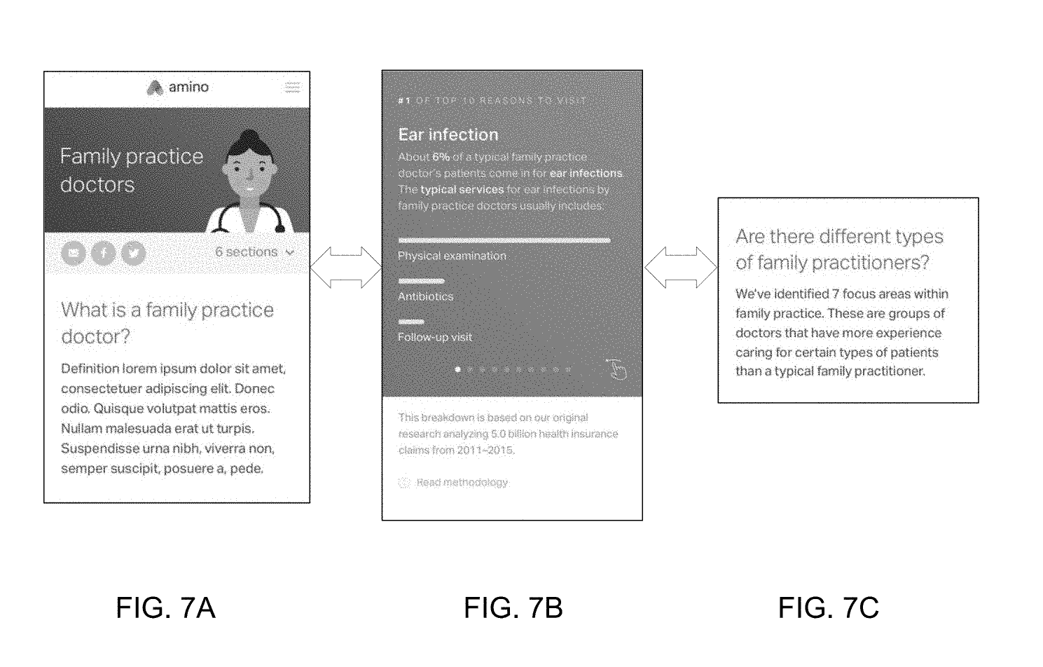

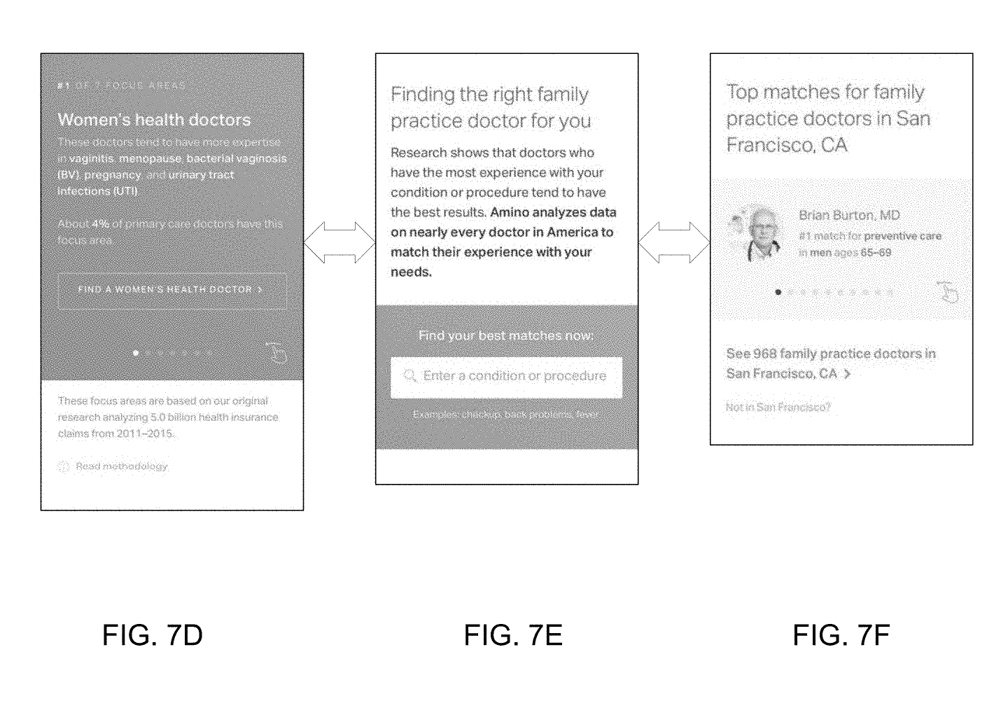

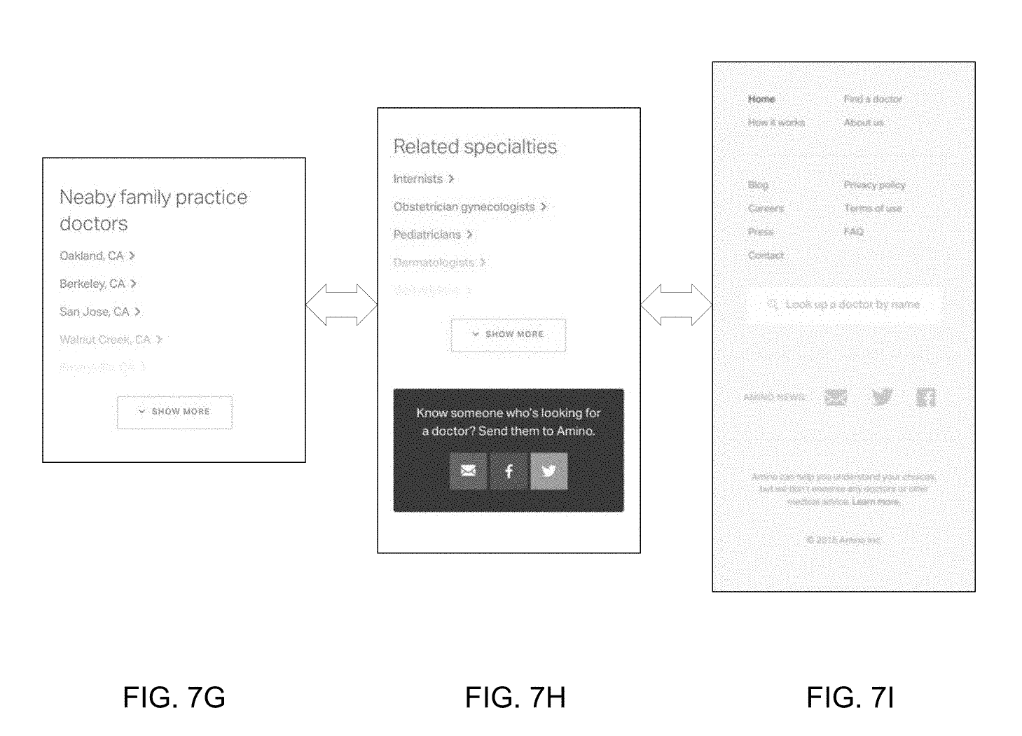

FIGS. 7A through 7I are screenshots of sequential pages that are accessed by scrolling the UI according to some embodiments of the present disclosure. Each page of corresponding FIGS. 7A through 7I includes healthcare information that may be obtained from the focus areas server 12 over network 18 of system 10. As such, a user of a healthcare consumer device 14 can access information from the disclosed clustering technology of system 10 to, for example, facilitate making decisions to identify a suitable healthcare provider.

Specifically, FIG. 7A shows a page that could describe the scope of care provided by family practice doctors. FIG. 7B shows a page that describes a common reason for visiting family practice doctors. FIG. 7C shows a page that summarizes the number of focus areas within family practice and sub-specialties.

FIG. 7D shows a page that describes a “women's health” focus area and provides a link to find a doctor in that focus area. FIG. 7E shows a page including a portal to search for a healthcare provider by utilizing the disclosed clustering technology. For example, a user may input a description of a condition or procedure into the textbox to search for a matching doctor. FIG. 7F shows a page including the results of a search for a doctor matching the clinical focus areas of “preventative care in men ages 65-69.”

FIG. 7G shows a page that lists family practice doctors by locations. FIG. 7H shows a page that lists related specialties and provides a feature for sharing content. Lastly, FIG. 7I shows a page that includes links to sections of the app, links to information related to the provider of the app, and a feature to search for a doctor by name.

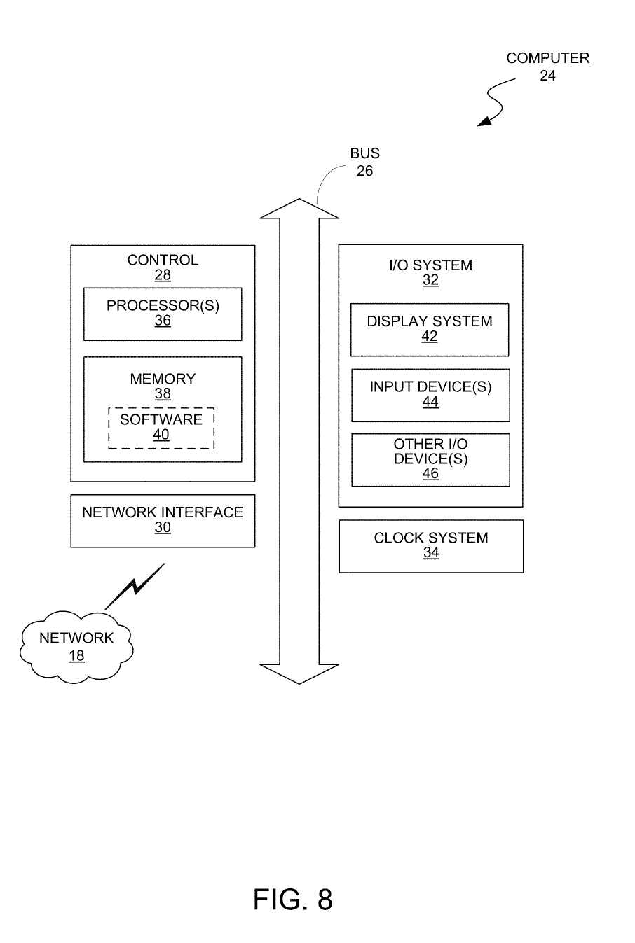

FIG. 8 is a block diagram of a computer 24 of system 10 operable to implement the disclosed technology according to some embodiments of the present disclosure. The computer 24 may be a generic computer or specifically designed to carry out features of system 10. For example, the computer 24 may be a System-On-Chip (SOC), a Single-Board Computer (SBC) system, a desktop or laptop computer, a kiosk, a mainframe, a mesh of computer systems, a handheld mobile device, or combinations thereof.

The computer 24 may be a standalone device or part of a distributed system that spans multiple networks, locations, machines, or combinations thereof. In some embodiments, the computer 24 operates as a server computer (e.g., the focus areas server 12) or a client device (e.g., the healthcare consumer device 14) in a client-server network environment, or as a peer machine in a peer-to-peer system. In some embodiments, the computer 24 may perform one or more steps of the disclosed embodiments in real-time, near real-time, offline, by batch processing, or combinations thereof.

As shown, the computer 24 includes a bus 26 operable to transfer data between hardware components. These components include a control 28 (i.e., processing system), a network interface 30, an Input/Output (I/O) system 32, and a clock system 34. The computer 24 may include other components not shown, nor further discussed for the sake of brevity. One having ordinary skill in the art will understand any hardware and software included but not shown in FIG. 8.

The control 28 includes one or more processors 36 (e.g., Central Processing Units (CPUs), Application Specific Integrated Circuits (ASICs), and/or Field Programmable Gate Arrays (FPGAs)) and memory 38 (which may include software 40). The memory 38 may include, for example, volatile memory such as Random Access Memory (RAM) and/or non-volatile memory such as Read Only Memory (ROM). The memory 38 can be local, remote, or distributed.

A software program (e.g., software 40), when referred to as “implemented in a computer-readable storage medium,” includes computer-readable instructions stored in a memory (e.g., memory 38). A processor (e.g., processor 36) is “configured to execute a software program” when at least one value associated with the software program is stored in a register that is readable by the processor. In some embodiments, routines executed to implement the disclosed embodiments may be implemented as part of Operating System (OS) software (e.g., Microsoft Windows®, Linux®) or a specific software application, component, program, object, module or sequence of instructions referred to as “computer programs.”

As such, the computer programs typically comprise one or more instructions set at various times in various memory devices of a computer (e.g., computer 24) and which, when read and executed by a at least one processor (e.g., processor 36), cause the computer to perform operations to execute features involving the various aspects of the disclosure embodiments. In some embodiments, a carrier containing the aforementioned computer program product is provided. The carrier is one of an electronic signal, an optical signal, a radio signal, or a non-transitory computer-readable storage medium (e.g., the memory 38).

The network interface 30 may include a modem or other interfaces (not shown) for coupling the computer 24 to other computers over the network 18. The I/O interface 32 may operate to control various I/O devices including peripheral devices such as a display system 42 (e.g., a monitor or touch-sensitive display) and one or more input devices 44 (e.g., a keyboard and/or pointing device). Other I/O devices 46 may include, for example, a disk drive, printer, scanner, or the like. Lastly, the clock system 34 controls a timer for use by the disclosed embodiments.

Operation of a memory device (e.g., memory 38), such as a change in state from a binary one to a binary zero (or vice-versa) may comprise a visually perceptible physical transformation. The transformation may comprise a physical transformation of an article to a different state or thing. For example, a change in state may involve accumulation and storage of charge or release of stored charge. Likewise, a change of state may comprise a physical change or transformation in magnetic orientation, or a physical change or transformation in molecular structure, such as from crystalline to amorphous or vice versa.

Aspects of the disclosed embodiments may be described in terms of algorithms and symbolic representations of operations on data bits stored on memory. These algorithmic descriptions and symbolic representations generally include a sequence of operations leading to a desired result. The operations require physical manipulations of physical quantities. Usually, though not necessarily, these quantities take the form of electrical or magnetic signals capable of being stored, transferred, combined, compared, and otherwise manipulated. Customarily, and for convenience, these signals are referred to as bits, values, elements, symbols, characters, terms, numbers, or the like. These and similar terms are associated with physical quantities and are merely convenient labels applied to these quantities.

While embodiments have been described in the context of fully functioning computers, those skilled in the art will appreciate that the various embodiments are capable of being distributed as a program product in a variety of forms, and that the disclosure applies equally regardless of the particular type of machine or computer-readable media used to actually effect the distribution.

While the disclosure has been described in terms of several embodiments, those skilled in the art will recognize that the disclosure is not limited to the embodiments described herein, and can be practiced with modifications and alterations within the spirit and scope of the invention. Those skilled in the art will also recognize improvements to the embodiments of the present disclosure. All such improvements are considered within the scope of the concepts disclosed herein and the claims that follow. Thus, the description is to be regarded as illustrative instead of limiting.

1. A server computer operable to identify one or more focus areas, the server computer comprising:
one or more processors; and
memory containing instructions executable by the one or more processors whereby the server computer is operable to:
obtain, from one or more source devices, healthcare information; and
identify one or more focus areas based on the healthcare information to thereby provide one or more identified focus areas.

2. The server computer of claim 1, wherein the server computer is further operable to:
receive, from a consumer device, a request for identifying one or more healthcare providers; and
provide, to the consumer device, a list comprising one or more healthcare providers in at least one of the one or more identified focus areas.

3. The server computer of claim 1, wherein the server computer is further operable to provide, to the one or more source devices, the one or more identified focus areas and classifications for a plurality of healthcare providers in accordance with the one or more identified focus areas.

4. The server computer of claim 1, wherein the healthcare information comprises at least one of procedures or diagnoses associated with a plurality of healthcare providers.

5. The server computer of claim 4, wherein the server computer is further operable to:
determine a pattern of care for each of the plurality of healthcare providers by normalizing each of the plurality of healthcare providers with respect to the at least one of procedures or diagnoses associated with the plurality of healthcare providers;
embed the pattern of care of each of the plurality of healthcare providers as a data point in a multi-dimensional space; and
generate one or more clusters of spatially close data points in the multi-dimensional space, wherein the one or more identified focus areas correspond to the one or more clusters.

6. The server computer of claim 5, wherein the server computer is further operable to, in accordance with the one or more identified focus areas:
classify a healthcare provider;
reclassify a healthcare provider; and
identify a healthcare provider that has been misclassified.

7. The server computer of claim 5, wherein the server computer is further operable to determine an average healthcare provider for each of the one or more clusters.

8. The server computer of claim 5, wherein the multi-dimensional space includes a number of dimensions corresponding to a number of the at least one of procedures or diagnoses provided by the plurality of healthcare providers.

9. The server computer of claim 5, wherein the one or more clusters is a predetermined number of clusters.

10. The server computer of claim 5, wherein the one or more clusters are generated by performing a k-means clustering operation on the data points in the multi-dimensional space.

11. A method performed by a server computer operable to identify one or more focus areas, comprising:
obtaining, from one or more source devices, healthcare information; and
identifying one or more focus areas based on the healthcare information to thereby provide one or more identified focus areas.

12. The method of claim 11, further comprising:
receiving, from a consumer device, a request for identifying one or more healthcare providers; and
providing, to the consumer device, a list comprising one or more healthcare providers in at least one of the one or more identified focus areas.

13. The method of claim 11, further comprising:
providing, to the one or more source devices, the one or more identified focus areas and classifications for a plurality of healthcare providers in accordance with the one or more identified focus areas.

14. The method of claim 11, wherein the healthcare information comprises at least one of procedures or diagnoses associated with a plurality of healthcare providers.

15. The method of claim 14, further comprising:
determining a pattern of care for each of the plurality of healthcare providers by normalizing each of the plurality of healthcare providers with respect to the at least one of procedures or diagnoses associated with the plurality of healthcare providers;
embedding the pattern of care for each of the plurality of healthcare providers as a data point in a multi-dimensional space; and
generating one or more clusters of spatially close data points in the multi-dimensional space, wherein the one or more identified focus areas correspond to the one or more clusters.

16. The method of claim 15, further comprising, in accordance with the one or more identified focus areas:
classifying a healthcare provider;
reclassifying a healthcare provider; and
identifying a healthcare provider that has been misclassified.

17. The method of claim 15, further comprising determining an average healthcare provider for each of the one or more clusters.

18. The method of claim 15, wherein the multi-dimensional space includes a number of dimensions corresponding to a number of the at least one of procedures or diagnoses provided by the plurality of healthcare providers.

19. The server computer of claim 15, wherein the one or more clusters is a predetermined number of clusters.

20. The server computer of claim 15, wherein the one or more clusters are generated by performing a k-means clustering operation on the data points in the multi-dimensional space.
